(19) United States
(12) Patent Application Publication
(10) Pub. No.: US 2018/0099369 A1
(43) Pub. Date: Apr. 12, 2018

(54) CUTTING TOOL WITH AUTO-STOP

(71) Applicant: RED WING SHOE COMPANY, INC., Red Wing, MN (US)

(72) Inventors: Robert Calvin Eastling, Plum City, WI (US); Timothy John Schneider, Red Wing, MN (US); Robert Dahl, Farmington, MN (US); Mark Eugene Malde, Rochester, MN (US); Amos Allen Huntley, Goodhue, MN (US); Kenneth Charles Baych, Chaska, MN (US)

(73) Assignee: RED WING SHOE COMPANY, INC., Red Wing, MN (US)

(21) Appl. No.: 15/289,386

(22) Filed: Oct. 10, 2016

(51) Int. Cl. B23Q 11/00; B23Q 17/24; H04N 7/18; G06K 9/46; H04N 9/09; G06K 9/00

(52) U.S. Cl. CPC B23Q 11/0082; B23Q 17/2438; B23Q 17/2409; G06K 9/00375; G06K 9/4652; H04N 9/09; H04N 7/181

(57) ABSTRACT

The present disclosure provides a system and method for automatically stopping powered machinery, which employs a number of vision sensors. In one embodiment, the system includes vision sensors arranged such that they image different zones defined relative to the cutting tool. The images captured by the vision sensors are processed by the system in real time. If the user's body (e.g., hands) is deemed to be in an unsafe area relative to the cutting tool, the system is configured to automatically stop the cutting tool.

### TECHNICAL FIELD

The present disclosure provides a safety system and method for automatically stopping a cutting tool.

### BACKGROUND

Powered cutting tool can injure users when the user inadvertently contacts the cutting element. Often power tools are outfitted with mechanical guards that are designed to minimize the likelihood of injury due to accidental contact with the cutting element. Mechanical guards are often used in applications where there are predictable engagement angles and pathways between the material to be cut or otherwise reduced (sanded, ground, crushed, etc.) and the cutting tool. Mechanical guards are also employed when relatively large portions or areas of the cutting tool are not otherwise used in normal operation as those portions can be more permanently shielded or otherwise covered up without decreasing the effectiveness of the tool. In applications where the majority of the cutting tool is used for cutting and there are many angles and pathways for engagement with the cutting tool exist in normal operation, mechanical guards are often less than ideal.

### SUMMARY

The present disclosure provides a system and method for automatically stopping powered machinery, which employs a number of vision sensors. In one embodiment, the system includes vision sensors arranged such that they image different zones defined relative to the cutting tool. The images captured by the vision sensors are processed by the system in real time. If the user's body (e.g., hands) are deemed to be in an unsafe area relative to the cutting tool, the system is configured to automatically stop the cutting tool.

### BRIEF DESCRIPTION OF THE FIGURES

FIG. 1 is a schematic illustration of an embodiment of the automatic stop system of the present disclosure;

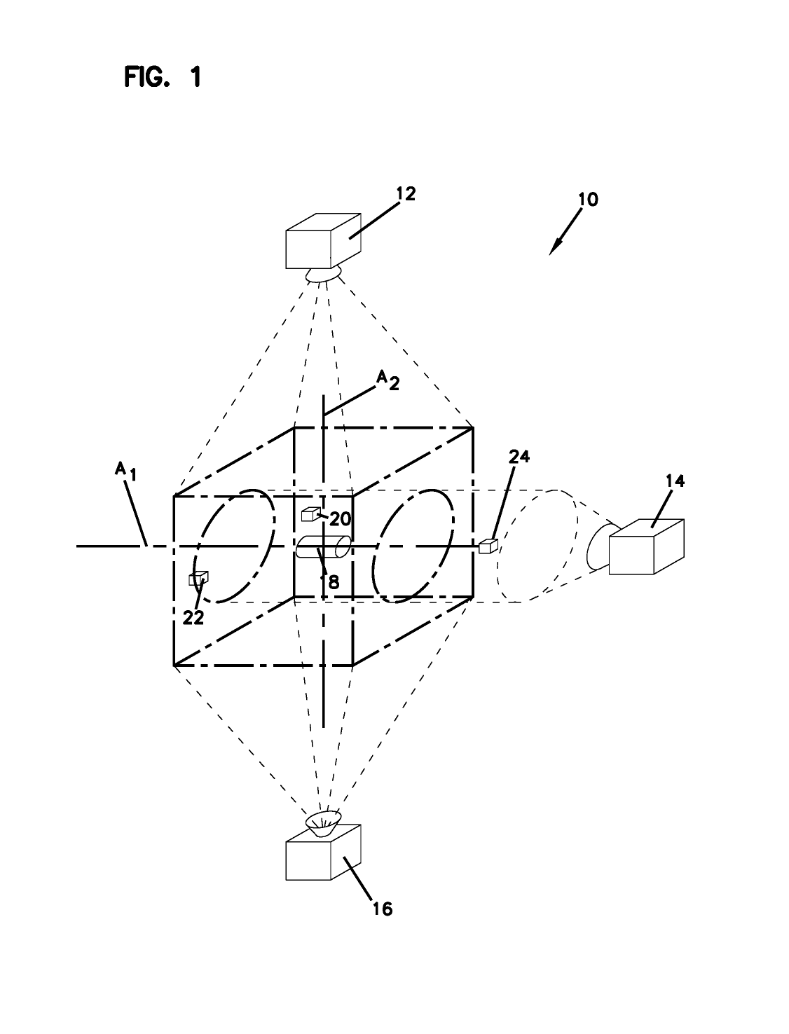

FIG. 2 is a schematic illustration of a portion of the system of FIG. 1;

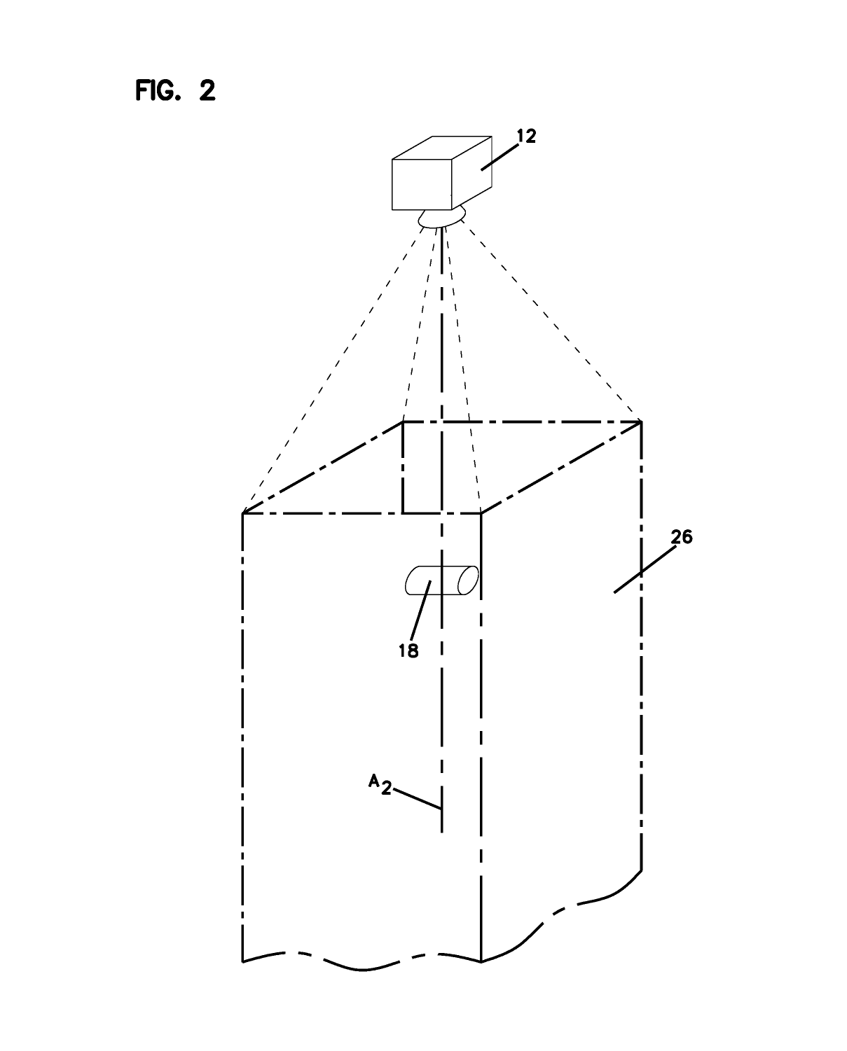

FIG. 3 is a schematic illustration of a portion of the system of FIG. 1; and

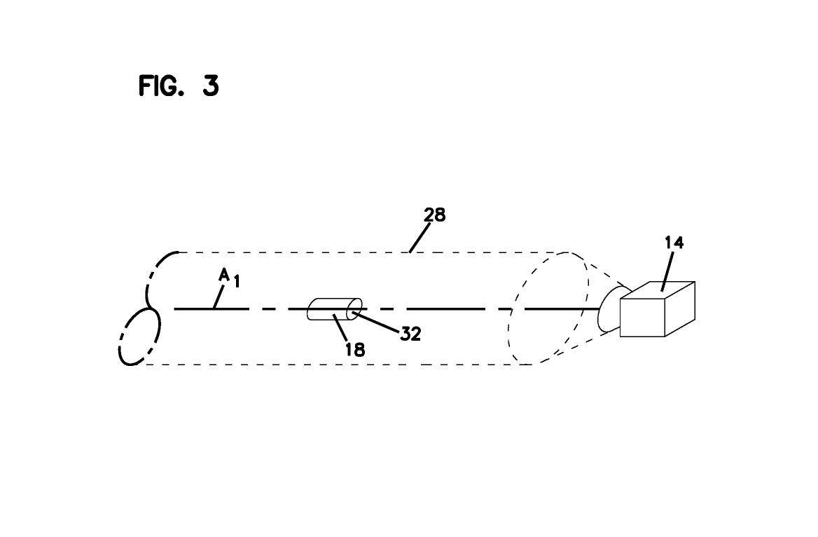

FIG. 4 is a schematic illustration of a portion of the system of FIG. 1.

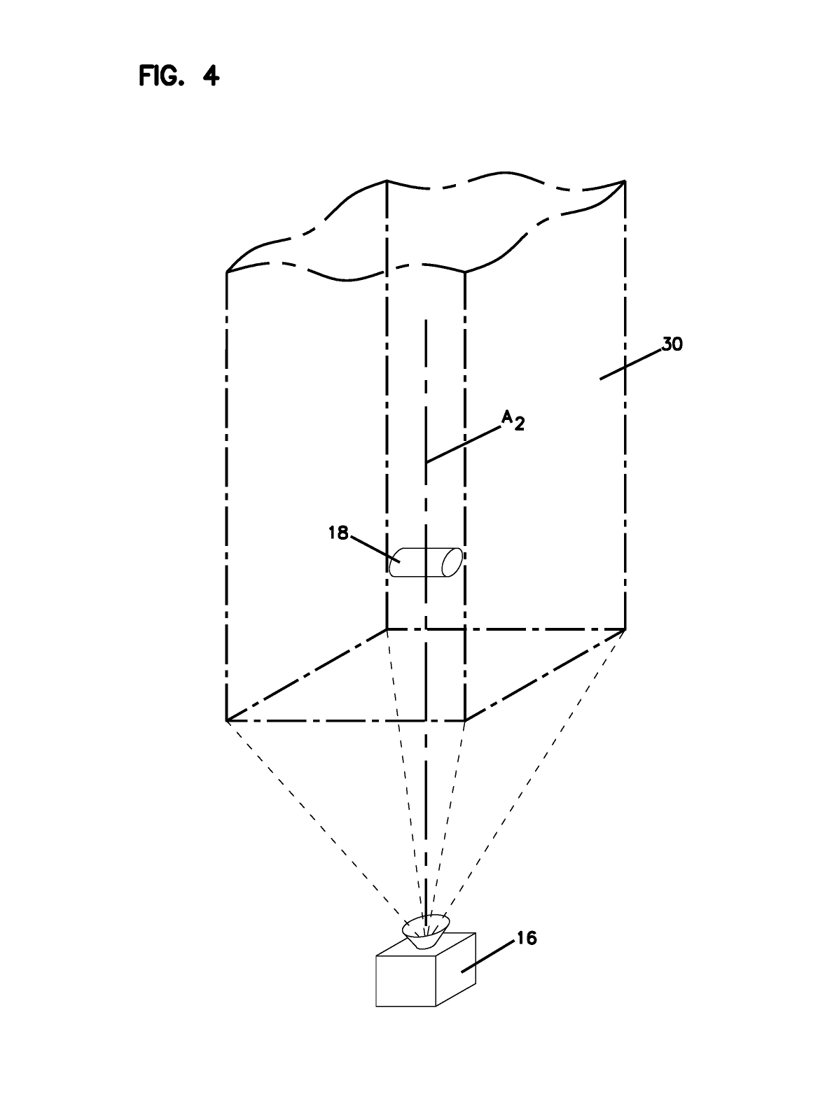

### DETAILED DESCRIPTION

Referring generally to the figures, an embodiment of the automatic stop system of the present disclosure is described herein. In the depicted embodiment, the system 10 includes a cutting tool 18. The cutting tool 18 including a first end portion, a second end portion, a top portion, a bottom portion, a first side portion, and a second side portion. In the depicted embodiment, the cutting tool includes a cylindrical body with fluted blades thereon. It should be appreciated that the cutting tool could be any number of different types of tools including for example, a cutting wheel, a drill bit, a saw, a grinding wheel, a flame, a laser, a punch, etc. The term cutting tool is used herein for simplicity and generally refers herein to any tool that could cause injury to a user.

In the depicted embodiment, cutting tool 18 is orientated along a first axis A1, a second axis A2, wherein the second axis is perpendicular to the first axis. In the depicted embodiment, the cutting tool including an end portion 32 is perpendicular to the first axis.

In the depicted embodiment, the system includes a first video camera 14 orientated such that it monitors a first zone 28. In the depicted embodiment, a first end portion of the cutting tool 18 is within the first zone 28. The first zone 28 extends above the top portion of the cutting tool 18 and below the bottom portion of the cutting tool 18. In the depicted embodiment, the first video camera 14 is located along the first axis A1. In the depicted embodiment the first zone 28 has a circular cross section.

In the depicted embodiment, the system includes a second video camera 12 orientated such that it monitors a second zone 26. In the depicted embodiment, a portion of the top portion of the cutting tool 18 is within the second zone 26. The second zone 26 extends around least a portion the first end portion of the cutting tool 18. In the depicted embodiment, the second video camera 12 is located above the cutting tool 18. In the depicted embodiment, the second video camera 12 is located along the second axis A2. In the depicted embodiment the second zone 28 has a rectangular cross section.

In the depicted embodiment, the system includes a third video camera 16 orientated such that it monitors a third zone 30. In the depicted embodiment, the bottom portion of the cutting tool 18 is within the third zone 30. The third zone 30 extends around least a portion the first end portion of the cutting tool 18. In the depicted embodiment, the third video camera 16 is located below the cutting tool 18. In the depicted embodiment, the third video camera 16 is also located along the second axis A2. In the depicted embodiment the third zone 30 has a rectangular cross section.

In the depicted embodiment, each of the first, second and third camera 12, 14, 16 is configured to image the first, second, and third zones 26, 28, 30 and output a control signal indicating whether a particular color has been identified as being within a zones of interest. In the depicted embodiment, the first, second and third cameras are vision sensors with a built-in processor, lighting, and optics. In the depicted embodiment, the color is green.

The cutting tool 18 is configured to auto stop the cutting tool if a particular color has been identified by the first, second and third cameras as being within the first zone 28 and at least one of the second 26 or third zones 30. In the depicted embodiment, the intersection of the first zone 28 with either or both of the second 28 and third 30 zone defines an auto kill zone. Many other configurations are also possible. For example, the auto stop can be activated when a particular color is identified in any two of the three zones.

In addition, in the depicted embodiment, the system is configured to auto stop the cutting tool 18 if any one of the first 14, second 12 and third 13 video cameras is misaligned. In the depicted embodiment, the system can include a tower light indicator 34 that identifies when the system cameras are properly aligned and functioning.

In the depicted embodiment, blower 36, 38, 40 are configured to blow particulate matter away from the video cameras 12, 14, 16. In the depicted embodiment, the system further comprises a ionizing element 42 configured to de electrify particulate matter that is processed by the cutting tool 18.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

We claim:

1. A machine with auto stop comprising:
a cutting tool, the cutting tool including a first end portion, a second end portion, a top portion, a bottom portion, a first side portion, and a second side portion;
wherein cutting tool is orientated along a first axis and a second axis, wherein the second axis is perpendicular to the first axis, the cutting tool including an end portion perpendicular to the first axis;
a first video camera orientated such that it monitors a first zone, wherein at least the first end portion of the cutting tool is within the first zone, and wherein the first zone extends above the top portion of the cutting tool and below the bottom portion of the cutting tool;
a second video camera orientated such that it monitors a second zone, wherein at least a portion of the top portion of the cutting tool is within the second zone, and wherein the second zone extends around least a portion the first end portion of the cutting tool;
a third video camera orientated such that it monitors a third zone, wherein at least a portion of the bottom portion of the cutting tool is within the third zone, and wherein the third zone extends around least a portion the first end portion of the cutting tool;
wherein each of the first, second and third camera is configured to image the first, second, and third zones and output a control signal indicating whether a particular color has been identified as being within a zone of interest; and
wherein the cutting tool is configured to auto stop the cutting tool if a particular color has been identified by the first, second and third cameras as being within at least two of the first zone, second, or third zones.

2. The machine of claim 1, wherein the cutting tool is configured to auto stop the cutting tool if a particular color has been identified by the first, second and third cameras as being within the first zone and at least one of the second or third zones.

3. The machine of claim 1, wherein the first video camera is located along the first axis.

4. The machine of claim 1, wherein the second video camera is located above the cutting tool and wherein the third video camera is located below the cutting tool.

5. The machine of claim 1, wherein the second video camera is located above the cutting tool on the second axis and wherein the third video camera is located below the cutting tool on the third axis.

6. The machine of claim 1, wherein the cutting tool is a milling tool including a cylindrical body and wherein the body portion includes fluted blades thereon.

7. The machine of claim 1, wherein the system is configured to auto stop the cutting tool if any one of the first, second and third video camera is misaligned.

8. The machine of claim 1, further comprises a tower light indicator that identifies when the system cameras are properly aligned and functioning.

9. The machine of claim 1, further comprises a blower configured to blow particulate matter away from at least one of the video cameras.

10. The machine of claim 1, wherein the color is green.

11. The machine of claim 1, further comprises a ionizing configured to de electrify particulate matter that is processed by the cutting tool.

12. The machine of claim 1, wherein the first, second and third cameras is a vision sensor with a built in processor, lighting, and optics.

13. The machine of claim 1, wherein the first zone has a circular cross section.

14. The machine of claim 1, wherein the second zone has a rectangular cross section.

15. The machine of claim 1, wherein the third zone has a rectangular cross section.

16. The machine of claim 1, wherein the intersection of the first zone with either or both of the second and third zone defines an auto kill zone.

17. The machine of claim 1, wherein the shape of the auto kill zone is the same as the working shape of the cutting tool and larger than the cutting tool.
